(19) United States
(12) Patent Application Publication
(10) Pub. No.: US 2008/0278628 A1
(43) Pub. Date: Nov. 13, 2008

(54) CONTENT DISPLAY DEVICE, CONTENT DISPLAY METHOD, CONTENT DISPLAY SYSTEM, CONTENT DISPLAY PROGRAM, AND RECORDING MEDIUM

(75) Inventors: Masafumi HIRATA, Tokyo (JP); Hirofumi Furukawa, Chiba-shi (JP); Soichi Nitta, Narashino-shi (JP); Tatsuo Sudo, Chiba-shi (JP); Azusa Umemoto, Kizugawa-shi (JP); Aya Enatsu, Chiba-shi (JP); Masafumi Takahashi, Sakura-shi (JP); Takuya Kinoshita, Chiba-shi (JP); Kiyotaka Kashito, Kobe-shi (JP); Katsuo Doi, Sakurai-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka-shi (JP)

(21) Appl. No.: 11/867,112

(22) Filed: Oct. 4, 2007

Related U.S. Application Data
(60) Provisional application No. 60/849,780, filed on Oct. 6, 2006.

(51) Int. Cl. H04N 5/445

(52) U.S. Cl. 348/564; 348/E05.105

(57) ABSTRACT

In a television, a single screen is split into a plurality of split-screens, and content displayed is different for each of the split-screens. In the television, the content selecting section selects content assigned in advance with each of the split-screens. A display section displays the content thus selected, on a corresponding one of the split-screens in a display. For example, a first split-screen displays a television program while a second split-screen displays a web page containing information on the television program. When a screen mode (pattern of split-screen) is changed, content corresponding to the screen modes is selected again and displayed. By the foregoing way, the content is displayed in a state suitable for respective split-screens.

This nonprovisional application claims the benefit under 35 U.S.C. § 119(e) of U.S. Provisional Application No. 60/849,780 filed on Oct. 6, 2006, the entire contents of which are hereby incorporated by reference.

### FIELD OF THE INVENTION

The present invention relates to a content display device, a content display method, a content display system, a content display program, and a storage media, by which a single display screen is split into a plurality of split-screens each displaying different content.

### BACKGROUND OF THE INVENTION

As televisions have been digitized and networked over the recent years, televisions provided with web browsers have become available, which allows users to browse web pages. Further, screens of latest televisions have increased in their size. Thus, there have been developed televisions with a screen that is split into a plurality of split-screens to display a web page and a television program concurrently.

Under the circumstances, techniques that facilitate browsing web pages have been developed. For example Japanese Unexamined Patent Publication No. 2006-31476 (Publication Date: Feb. 2, 2006) discloses an electronic device including: acquiring means for acquiring a web page; drawing means for internally drawing the web page acquired; determining means for determining whether an error occurs in a display when the drawn web page is displayed on a display section; converting means for converting the drawn web page so as to solve the error, when it is determined that the error occurs; and display means for causing the display section to display the converted web page.

With this electronic device, a display that is suited to display environment and easy for users to browse is shown reliably regardless of description languages of web pages and characters of browsers.

However, the foregoing conventional technique does not disclose a relationship between splitting a single screen into a plurality of split-screens and conversion of web pages. Accordingly, a web page is converted in the same manner for the respective split-screens. Thus, it is not possible to generate and display a suitable web page for each of the split-sections (screens).

The present invention is in view of the foregoing problems, and has as an object to provide a content display device, a content display method, a content display system, a content display program, and a recording medium, by which content is displayed in a state suitable for each split-screen.

### SUMMARY OF THE INVENTION

### Content Display Device

To solve the problems above, a content display device of the present invention is adapted so that a content display device in which a single screen is split into a plurality of split-screens each displaying different content, includes: content selecting means for selecting, for each of the plurality of split-screens, content assigned in advance to each of the plurality of split-screens; and content displaying means for displaying the content selected, on a corresponding one of the plurality of split-screens.

With this configuration, the content display device displays suitable content that corresponds to the respective split-screens. For example if the single screen is not split, the content display device displays a web page containing the largest amount of information. If the screen is split by two, the content display device displays a television program on one split-screen, and displays, on the other split-screen, content that is relevant to, but contains a smaller amount of information than, the content displayed when the screen is not split. If the screen is split by three, the content display device selects and displays another suitable content.

Thus, the content display device produces an advantageous effect that content is displayed in a state suitable for each split-screen.

(Content Display Method)

To solve the problems above, a content display method of the present invention is adapted so that a content display method in which a single screen is split into a plurality of split-screens each displaying different content includes: selecting, for each of the plurality of split-screens, content assigned in advance to each of the plurality of split-screens; and displaying the content selected, on a corresponding one of the plurality of split-screens.

This arrangement produces the same advantageous effect as that produced by the content display device of the present invention.

(Content Display System)

A content display system is adapted so that the system includes: a content display device in which a single screen is split into a plurality of split-screens each displaying different content; and a server device that provides the content to the content display device. The content display device includes: transmitting means for transmitting, to the server device, information on the plurality of split-screens; and content displaying means for displaying the content transmitted from the server device, on a corresponding one of the plurality of split-screens. The server device includes: receiving means for receiving the information on the plurality of split-screens, which information is transmitted from the display device; content selecting means for selecting, on a basis of the information thus received, corresponding content for each of the plurality of split-screens; and content transmitting means for transmitting, to the content display device, the content thus selected.

With this configuration, an advantageous effect is produced that a content display system by which content is displayed in a state suitable for each split-screen is provided.

The content display device is also realizable by a computer. In this case, the scope of the present invention includes: a content display program for causing a computer to operate as each of the means above so that the content display device is realized in the computer; and a computer-readable recording medium storing the content display program.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram showing a configuration of a main part of a television in accordance with an embodiment of the present invention.

FIG. 2 is a block diagram showing a configuration of a main part of a content display system in accordance with an embodiment of the present invention.

FIG. 3 is a block diagram showing a configuration of a main part of a content providing server.

FIG. 4 is a figure showing patterns of split-screens of respective screen modes.

FIG. 5 is a menu that the television displays when a screen mode is to be switched.

FIG. 6 is a figure showing an exemplary set of a current screen mode and channel numbers of television programs displayed on the split-screens, which current screen mode and the channel numbers are stored in a memory of the television.

FIG. 7 is a figure showing exemplary data that a content-acquisition-request transmitting section transmits to a content providing server.

FIG. 8 is a figure showing exemplary template data.

FIG. 9 is a figure showing exemplary template data for a screen.

FIG. 10 is a figure showing exemplary content that is to be displayed.

FIG. 11 is a figure showing template data for generating a suitable web page for screen mode 2 (there are two split-screens).

FIG. 12 is a figure specifically showing details of a process carried out in regard to a get_info tag.

FIG. 13 is a figure showing Toppage.html generated by processing Toppage_mode3.html.

FIG. 14 is a figure showing an exemplary display of Toppage.html.

FIG. 15 is a flowchart showing a flow in a process of displaying content in the content display system.

FIG. 16 is a flowchart showing a flow in a process executed by the content providing server.

FIG. 17 is a flowchart showing another flow of a process of displaying content in the content display system.

FIG. 18 is a flowchart showing another flow of process of displaying content in the content display system.

FIG. 19 is a figure showing an exemplary single piece of content corresponding to all screen modes.

### DESCRIPTION OF THE EMBODIMENTS

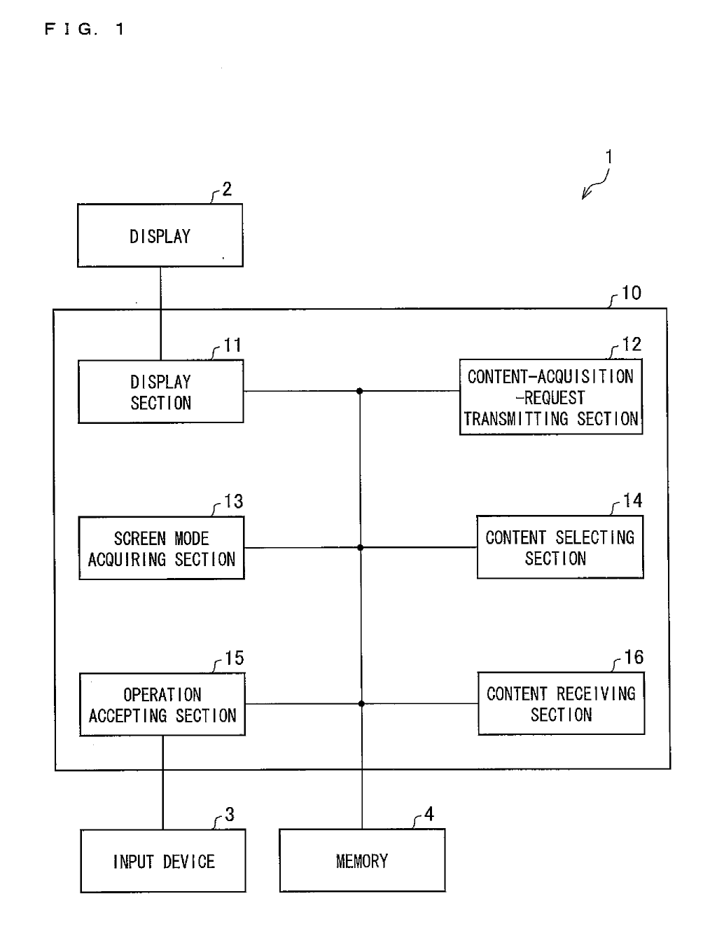

The following describes an embodiment of the present invention, with reference to FIGS. 1 to 18.

(Content Display System 30)

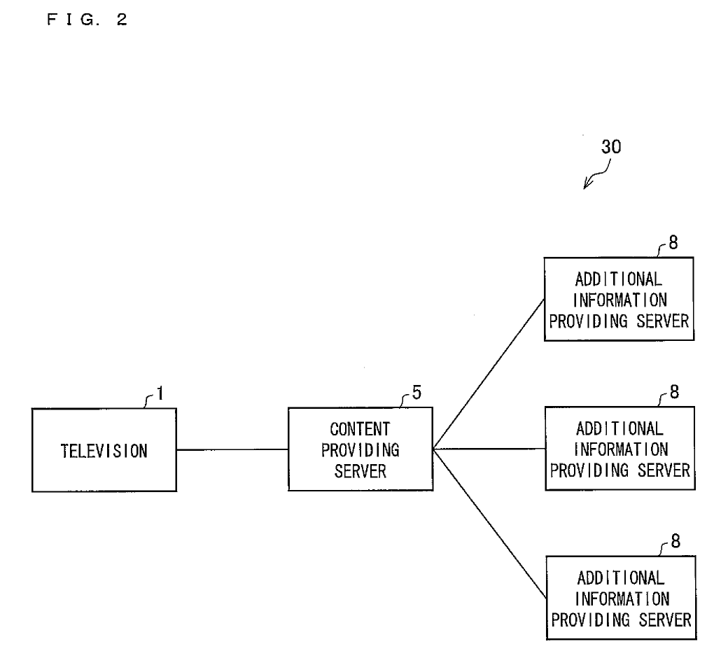

The following describes a content display system 30 of the present embodiment, with reference to FIG. 2. FIG. 2 is a block diagram showing a configuration of a main part of the content display system 30 in accordance with an embodiment of the present invention. As shown in this figure, the content display system 30 includes a television 1 (content display device), a content providing server 5, and an additional information providing server 8.

(Configuration of Television 1)

The television 1 receives a television program that is on air, and displays the television program. Further, the television 1 displays web pages acquired via networks.

The following describes the television 1 of the present embodiment, with reference to FIG. 1. FIG. 1 is a block diagram showing a configuration of a main part of the television 1 in accordance with an embodiment of the present invention. As shown in this figure, the television 1 includes a display 2, an input device 3, a memory 4, and a controller 10.

(Display 2)

The display 2 displays information for users to see. The display 2 is realized by a liquid crystal display device or a plasma display device, for example.

(Input Device 3)

A user utilizes the input device 3 to enter information into the television 1 and to select information shown on the display 2. The input device 3 is realized by a remote controller, a mouse, or a keyboard, for example.

(Memory 4)

The memory 4 stores various data that a content receiving section 16 uses when executing a process. The memory 4 corresponds to so-called nonvolatile memories or volatile memories.

(Controller 10)

The controller 10 takes charge of the processes executed in the television 1. The controller 10 includes, specifically, a display section 11 (content displaying means), a content-acquisition-request transmitting section 12, a screen-mode acquiring section 13, the content selecting section 14 (content selecting means), an operation accepting section 15, and the content receiving section 16 (content receiving means).

How those sections function and what processes are executed by those sections will be described later.

(Content Providing Server 5)

The content providing server 5 provides the television 1 with content that is to be displayed, on the display 2, by the television 1.

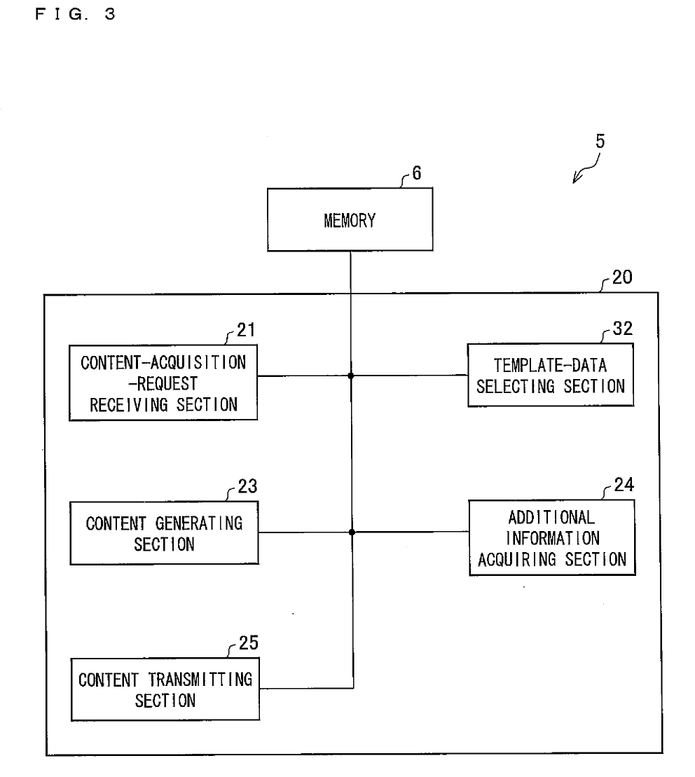

The following describes a configuration of the content providing server 5, with reference to FIG. 3. FIG. 3 is a block diagram showing a configuration of a main part of the content providing server 5. As shown in this figure, the content providing server 5 includes a memory 6 and a controller 20.

(Memory 6)

The memory 6 stores a variety of data that the controller 20 uses when executing a process. The memory 6 is realized by a nonvolatile memory or a volatile memory.

(Controller 20)

The controller 20 takes charge of the processes that are to be executed in the content providing server 5. The controller 20 includes, specifically, a content-acquisition-request receiving section 21, a template-data selecting section 22, a content generating section 23 (content generating means), an additional information acquiring section 24, and a content transmitting section 25 (content transmitting means).

How those sections function and what processes are executed by those sections will be described later.

(Additional Information Providing Server 8)

In response to a request from the content providing server 5, the additional information providing server 8 provides the content providing server 5 with predetermined additional information that the content providing server 5 needs when generating content.

(Pattern of Split-Screens)

The television 1 of the present embodiment splits a screen of the display 2 into a plurality of split-screens. The split-screens can display different content from each other or one another. For example if the screen is split by two, a left split-screen displays a television program while a right split-screen displays a web page relevant to the television program. If the screen is split by three, two left split-screens display television programs of different channels while a right split-screen displays a web page.

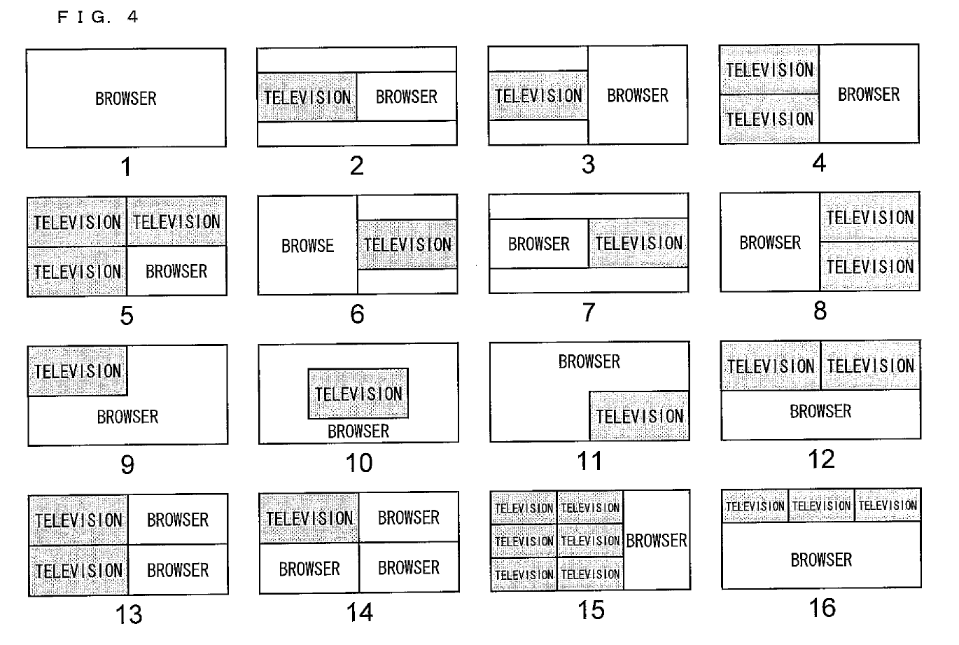

The screen of the display 2 can be split into any shapes and numbers in the television 1. For example when a user operates the input device 3 to specify a screen mode, this operation is accepted by the operation accepting section 15. At this time, the television 1 stores, in the memory 4, a predetermined screen mode corresponding to a particular split pattern of the split-screens. The following describes the screen modes settable with the television 1, with reference to FIG. 4.

FIG. 4 shows patterns of the split-screens of the respective screen modes. As shown in this figure, 16 patterns of the screen modes are settable with the television 1. For example in screen mode 1, only one type of content is displayed on the display 2. In the case shown in FIG. 4, content of a browser (web page) is displayed.

In screen mode 2, the screen of the display 2 is split by two to form a first split-screen and a second split-screen. The first split-screen displays content of a television (television program), and the second split-screen displays a web page.

The screen modes differ in the number of split-screens, in the size of the respective split-screens, and in the position of the respective split-screens. A relationship between a screen mode number and a pattern of the split-screens is stored in advance in the memory 4 of the television 1. The relationship is stored in a table format.

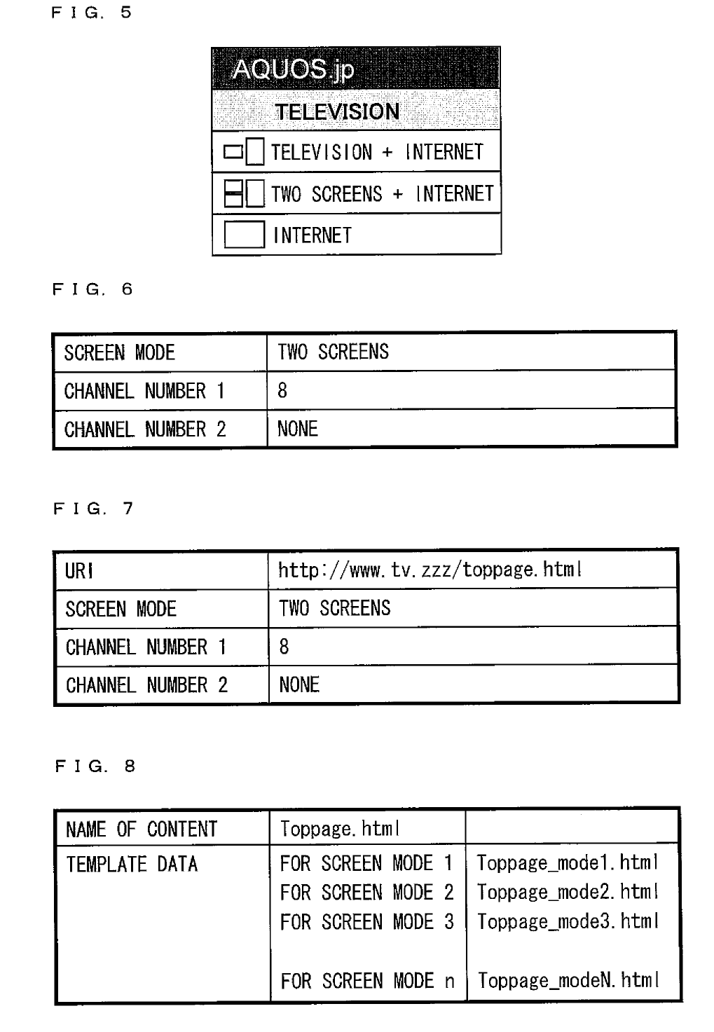

The television 1 switches the screen modes according to user operation. FIG. 5 shows a menu that the television 1 displays when the screen mode is to be switched. As shown in the menu in FIG. 5, the user selects one of the items on the menu to switch the screen mode of the television 1.

(Storing Information Such as Screen Modes)

FIG. 6 is a figure showing an exemplary set of a current screen mode and channels numbers of television programs that are to be displayed on the split-screens, stored in the memory 4 of the television 1. As shown in this figure, the television 1 stores, in the memory 4, the current screen mode and the channel numbers of the television programs that are to be displayed on the split-screens. In the case shown in FIG. 4, the memory 4 stores “2 screens” as the screen mode, “8” as channel number 1, and “none” as channel number 2. In other words, the television 1 currently operates in a two-screen mode with two split-screens. One of the split-screens displays a television program of channel 8, and the other one of the split-screens displays a web page relevant to the television program.

(Obtaining and Displaying Web Pages)

The television 1 acquires content to be displayed on the split-screens from the content providing server 5. To do so, the content providing server 5 selects suitable content according to the screen mode of the television 1, and transmits the content to the television 1.

In the television 1, the content-acquisition-request transmitting section 12 transmits, to the content providing server 5, a content acquisition request to make a request for acquisition of the content. Specifically, the television 1 reads out, from the memory 4, the current screen mode and the channel number of the television program that is currently displayed. The television 1 associates the current screen mode and the channel number with an address (URI) of a web page that is desired to be acquired, and then transmits the current screen mode and the channel number to the content providing server 5. An exemplary combination of information that is transmitted at this time is shown in FIG. 7. FIG. 7 is a figure showing exemplary data that the content-acquisition-request transmitting section 12 transmits to the content providing server 5. In the case shown in FIG. 7, the information shown in FIG. 6 is associated with an URI for acquiring Toppage.html and transmitted to the content providing server 5. Then, the content providing server 5 dynamically generates Toppage.html corresponding to the two-screen mode, and returns this Toppage.html to the television 1.

(Template Data)

In the content providing server 5, the content-acquisition-request receiving section 21 receives the content acquisition request transmitted from the television 1. Specifically, the content-acquisition-request receiving section 21 receives: the URI of the content that is requested to be acquired; the current screen mode of the television 1; and information on the channel. Using predetermined template data according to the screen mode thus received, the content generating section 23 generates suitable content according to the current screen mode of the television 1.

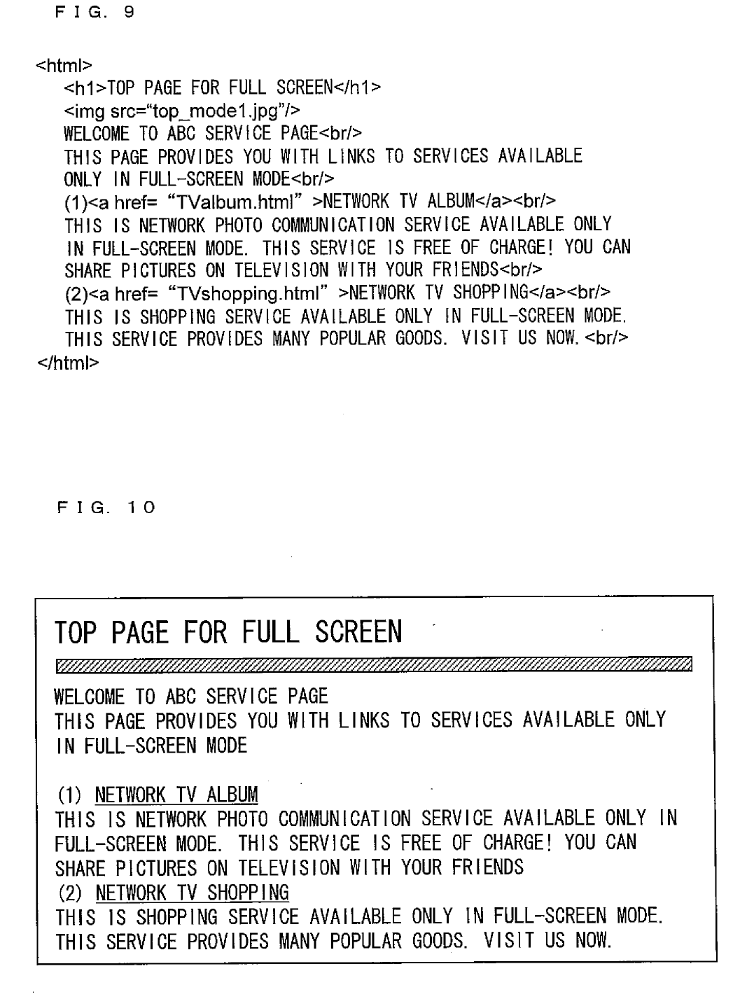

Exemplary template data used at this time is shown in FIG. 8. FIG. 8 is a figure showing exemplary template data. As shown in this figure, pieces of template data corresponding to the respective screen modes are stored in advance in the memory 6 of the content providing server 5. Specifically, for content Toppage.html, template data Toppage_modeN.html corresponding to number N of the screen mode is stored in the television 1, for each of the screen modes.

For example, for screen mode 1, Toppage_mode1.html is prepared for generating content that is suitable for a display on one screen. For screen mode 2, Toppage_mode2.html is prepared for generating content that is suitable for a display on a smaller split-screen formed as a result of splitting the screen by two. Any of the foregoing template data is to generate Toppage.html dynamically.

(Exemplary Template Data)

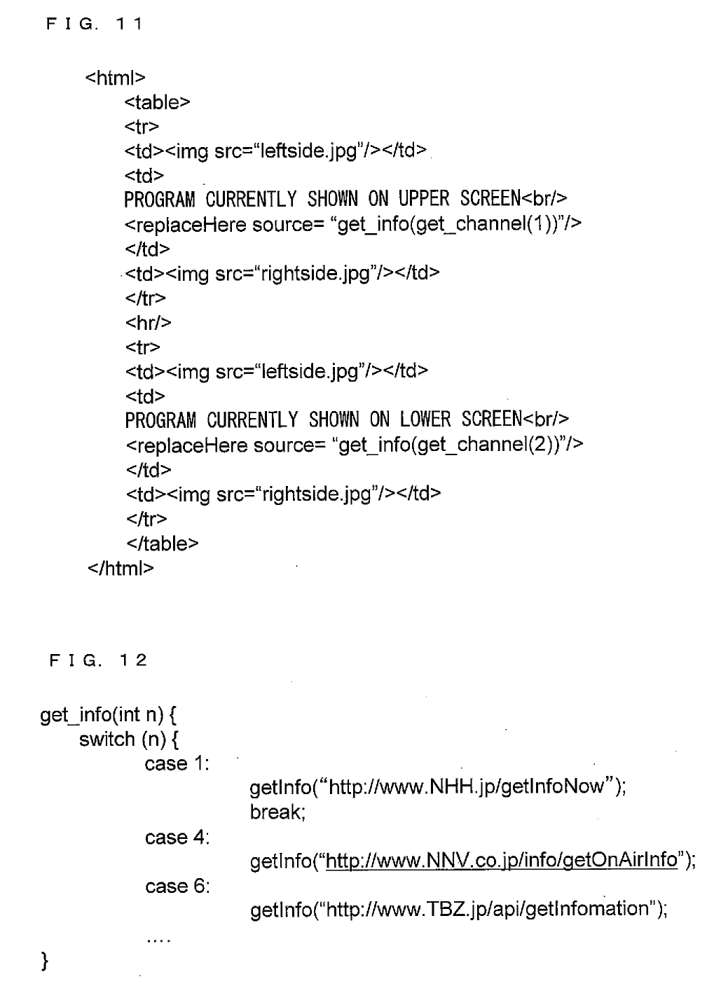

The following describes details of the template data (Toppage_mode1.html) for one-screen, with reference to FIG. 9. FIG. 9 is a figure showing exemplary template data for one-screen.

The template data shown in FIG. 9 is HTML data describing web pages. The template data is constituted of a tag, such as <html>, and texts that are to be shown on the screen.

The content for one screen does not need additional information on content that is displayed on other screen. Thus, the content generating section 23 generates Toppage.html for one screen without processing Toppage_mode1.html. Specifically, the content generating section 23 creates duplicate data with a different file name, thereby generating Toppage.html.

In the content providing server 5, the content generated by the content generating section 23 is transmitted to the television 1 by the content transmitting section 25. In the television 1, the content receiving section 16 receives the content transmitted from the content providing server 5. The display section 11 displays the content thus received, on the display 2.

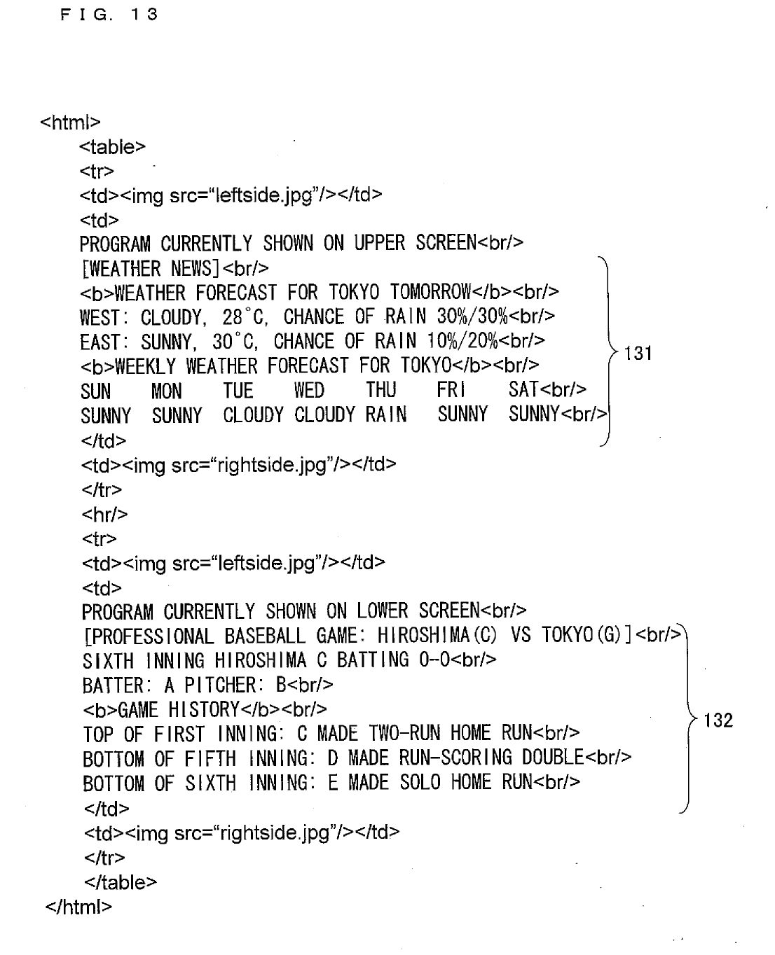

The display section 11 displays the content generated on the basis of the template data shown in FIG. 9, in the manner as shown in FIG. 10. FIG. 10 is a figure showing an exemplary display of the content. In the case shown in this figure, links to applications (net TV album, net TV shopping) available only in a full-screen mode (1 screen mode) are displayed. Specifically, when not splitting the screen of the display 2, the television 1 displays content that is suitable for one screen, which is the screen of the largest size.

(Template Data for Plural Screens)

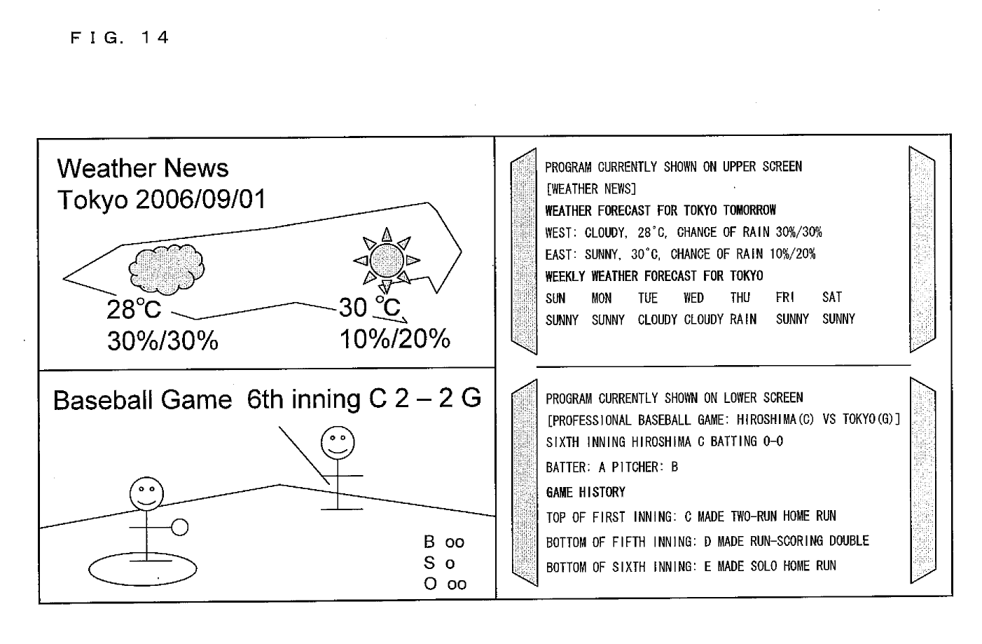

FIG. 11 is a figure showing template data for generating a web page that is suitable for screen mode 3 (there are three split-screens). When the television 1 is in screen mode 3, in which three split-screens each display content, the content providing server 5 generates Toppage.html with the use of Toppage_mode3.html shown in FIG. 11.

As shown in this figure, Toppage_mode3.html includes special tags for dynamically generating additional information (relevant information) on the pieces of content (television programs) shown on the respective two other split-screens. Concretely, the special tags are a replaceHere tag, a get_info tag, and a get_channel tag.

When making a request for the content of screen mode 3 to the content providing server 5, the television 1 transmits, to the content providing server 5, information on the channels of the television programs shown on those two other split-screens. Thus, when processing Toppage_mode3.html, the content selecting section 14 first processes a get_info (1) tag to acquire the channel number of the television program shown on the first split-screen. The content selecting section 14 then processes a get_info tag to acquire, from the additional information providing server 8, additional information that is to be embedded into the content.

(Processing the Get_Info Tag)

FIG. 12 is a figure specifically showing details of the process carried out in regard to the get_info tag. As shown in this figure, the additional information acquiring section 24 executes a getInfo function corresponding to an argument of the get_info tag. For example if the argument, that is to say the channel number, is one, an URI http://www.NHH.JP/geInfoNow is transmitted to the additional information providing server 8.

Then, the additional information providing server 8 transmits, to the content providing server 5, information on the television program that is currently on air. The additional information acquiring section 24 receives the additional information thus transmitted, and supplies the additional information to the content generating section 23. The content generating section 23 sets the entered information as the argument and executes the replaceHere tag, thereby embedding the additional information, provided by the additional information providing server 8, into a place where the replaceHere tag is defined.

In the same manner, the content generating section 23 executes the replaceHere tag with respect to the television program displayed on the other one of the split-screens, thereby embedding the additional information relevant to the television program displayed on the second split-screen.

Accordingly, the television 1 executes two replaceHere tags when processing Toppage_mode3.html shown in FIG. 11. As a result, pieces of additional information on those two respective television programs are dynamically embedded into the content that is to be generated.

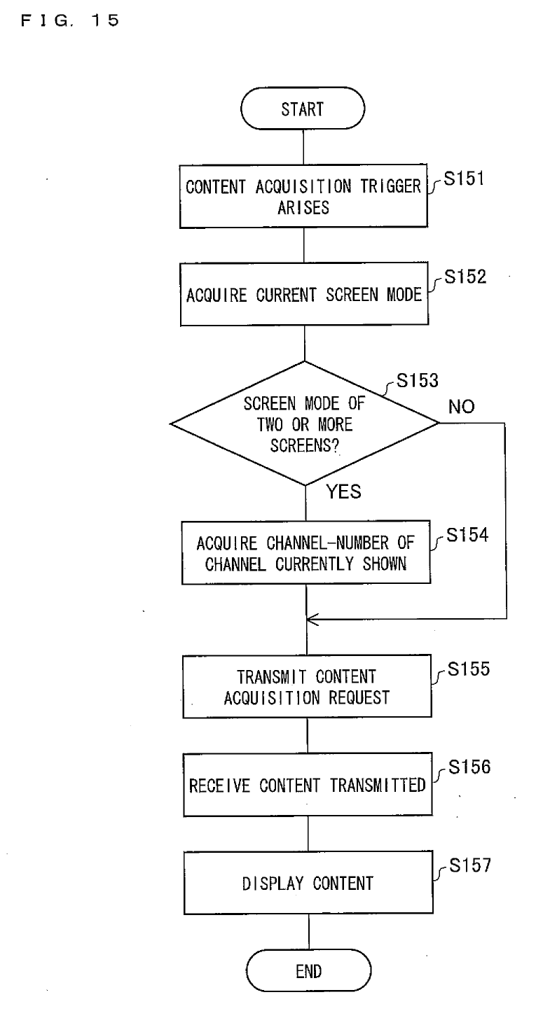

Exemplary content to be generated is shown in FIG. 13. FIG. 13 is a figure showing Toppage.html generated by processing Toppage_mode3.html. As shown in this figure, information on the television program (weather forecast) that is being displayed on the upper screen is embedded into one of two replaceHere tags, and information on the television program (professional baseball game) that is being displayed on the lower screen (the second split-screen) is embedded into the other one of the two replaceHere tags.

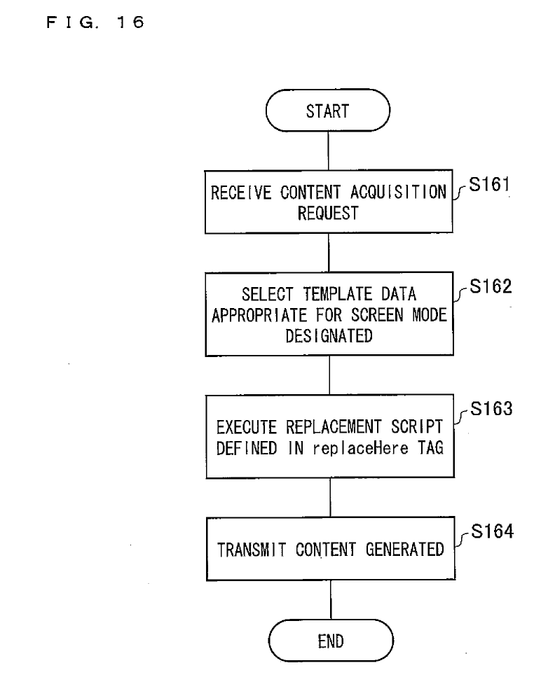

The television 1 displays, on the display 2, the content shown in FIG. 13, as shown in FIG. 14. As shown in this figure, the television program of the weather forecast is displayed on an upper-left split-screen among three split-screens, and the television program of the professional baseball game is displayed on a lower-left split-screen. Further, the web page containing information on the television programs displayed on those two left split-screens is displayed on a right split-screen.

(Flow in the Process of Displaying Content)

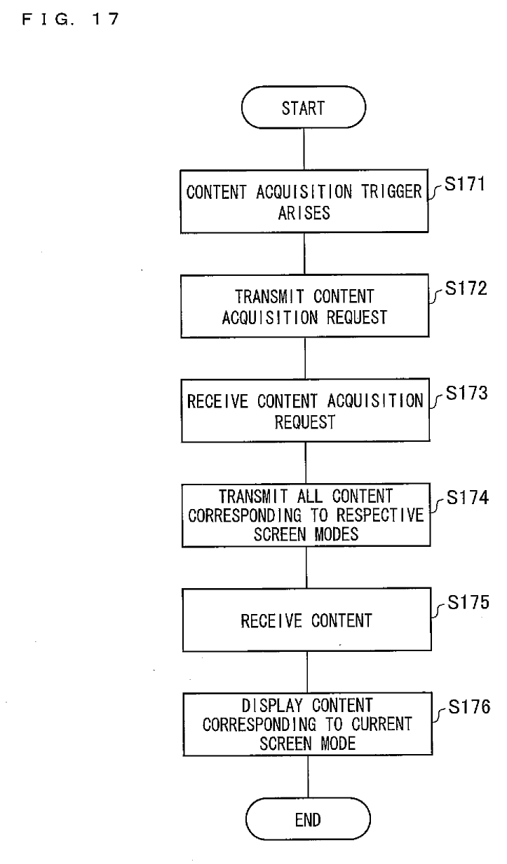

The following describes a flow in the foregoing process, with reference to FIG. 15. FIG. 15 is a flowchart showing the flow in the process of displaying content in the content display system 30.

As shown in this figure, first there arises a content acquisition trigger in the television 1 (step S151). The content acquisition trigger arises in the following events, for example: the screen mode is changed; the screen mode is not changed, but the channel of the television that is being browsed concurrently is changed; sound is muted; image quality is adjusted; a display of subtitles is switched; sound is switched.

When the content acquisition trigger arises, the screen-mode acquiring section 13 acquires the current screen mode from the memory 4 (step S152). The screen-mode acquiring section 13 supplies this acquired screen mode to the content-acquisition-request transmitting section 12. The content-acquisition-request transmitting section 12 determines whether the current screen mode is a mode of two or more screens (step S153).

If a result of this determination in step S153 is “TRUE” (Yes), then the content-acquisition-request transmitting section 12 acquires the channel number of the television currently displayed (step S154). If plural programs are displayed individually on the respective split-screens, the channel numbers of all of the programs are acquired.

Then, the content-acquisition-request transmitting section 12 transmits the content acquisition request to the content providing server 5 (step S155). Specifically, the content-acquisition-request transmitting section 12 transmits at least the current screen mode and the URI of the content that is to be acquired. Further, if the screen mode is a mode of two or more screens, the channel numbers of the television programs that are being displayed are transmitted concurrently.

When receiving the content acquisition request, the content providing server 5 generates suitable content according to the screen mode specified, and transmits the content to the television 1. This process will be specifically described later. In the television 1, the content receiving section 16 receives the content transmitted from the content providing server 5, and supplies this transmitted content to the display section 11 (step S156). The display section 11 displays this supplied content on a predetermined split-screen of the display 2.

Through the foregoing process, the television 1 displays, on the display 2, the suitable content according to the current split-screen. Thus, each split-screen displays the content in a suitable state.

(Process in the Content Providing Server 5)

The following describes a process in the content providing server 5 when the content acquisition request is received, with reference to FIG. 16. FIG. 16 is a flowchart showing a flow in the process carried out by the content providing server 5.

As shown in this figure, first the content-acquisition-request receiving section 21 receives the content acquisition request (step S161) in the content providing server 5. The content-acquisition-request receiving section 21 supplies the content generating section 23 with: the URI; the current screen mode of the television 1; and the channel number that are received. The content generating section 23 acquires, from the memory 6, template data according to (i.e. associated with) the screen mode entered (step S162).

Using the template data thus acquired, the content generating section 23 generates the content that is to be transmitted to the television 1. At this time, the content generating section 23 executes a replacement script defined in a replaceHere tag contained in the template data (step S163). For example, if the replaceHere tag defines a process of acquiring additional information on the television program, the content generating section 23 acquires, via the additional information acquiring section 24, the additional information on the television program from the additional information providing server 8, and embeds the additional information into the content that is to be generated.

Lastly, the content generated by the content generating section 23 is transmitted to the television 1 by the content transmitting section 25 (step S164). As the foregoing describes, the content receiving section 16 receives the content transmitted, and supplies the content to the display section 11 in the television 1.

(Operation and Effect)

As the foregoing describes, the television 1 displays, on each split-screen, suitable content that corresponds to the split-screen. For example if a single screen is not split, the television 1 displays a web page containing a largest amount of information. If the screen is split by two, one split-screen displays a television program, and the other split-screen displays content that is relevant to, but contains a smaller amount of information than, the content that is displayed when the screen is not split. If the screen is split by three, another suitable content is selected and displayed.

Accordingly, the television 1 displays the content on each split-screen in a suitable state. This allows the users to easily understand the content displayed.

The present invention is not limited to the description of the embodiments above, but may be altered by a skilled person within the scope of the claims. An embodiment based on a proper combination of technical means disclosed in different embodiments is encompassed in the technical scope of the present invention.

(Transmitting all Pieces of Content Corresponding to the Respective Screen Modes)

The content providing server 5 may transmit, at once to the television 1, all pieces of content that correspond to all screen modes selectable in the television 1, instead of transmitting one content that corresponds to a screen mode of the television 1, for example. In this case, the television 1 selects, among those pieces of content thus transmitted, content corresponding to the current screen mode, and displays the content on the display 2.

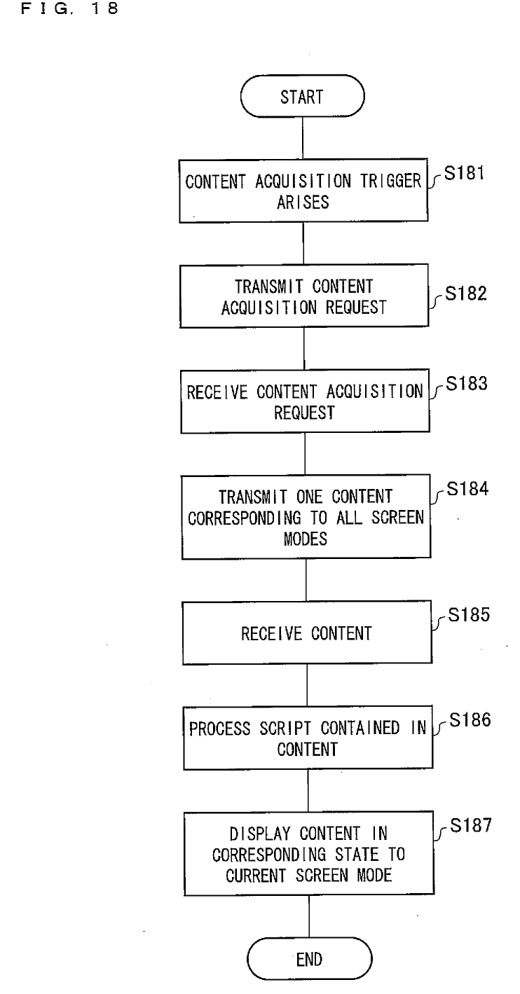

The following describes a flow in this process, with reference to FIG. 17. FIG. 17 is a flowchart showing another exemplary flow in the process of displaying the content in the content display system 30.

As shown in this figure, first there arises a content acquisition trigger (step S171). Then, the content-acquisition-request transmitting section 12 transmits a content acquisition request to the content providing server 5 (step S172). At this time, the content-acquisition-request transmitting section 12 only transmits an URI of the content that is desired to be acquired. In other words, the content-acquisition-request transmitting section 12 does not transmit information on the current screen mode.

In the content providing server 5, the content-acquisition-request receiving section 21 transmits the content acquisition request (step S173). In the content providing server 5, information on all screen modes settable with the television 1 are stored in advance in the memory 6. Further, pieces of content corresponding to the respective screen modes are prepared in advance. Thus, the content transmitting section 25 transmits, to the television 1, all pieces of content corresponding to the respective screen modes settable with the television 1 (step S174). For example, if 16 screen modes are settable with the television 1, the content transmitting section 25 transmits 16 pieces of content to the television 1. At this time, each content is associated with a screen-mode number of the corresponding screen mode, and then transmitted.

In the television 1, the content receiving section 16 receives the content transmitted from the content providing server 5 (step S175). The content receiving section 16 supplies the content selecting section 14 with all of the pieces of content thus received. At this time, the screen-mode acquiring section 13 acquires the current screen mode from the memory 4, and supplies the current screen mode to the content selecting section 14. The content selecting section 14 selects, among the pieces of content thus supplied, content that corresponds to the current screen mode (respective split-screens), and supplies the display section 11 with the content thus selected. Then, the display section 11 displays, on the display 2, the content thus supplied as the content corresponding to the current screen mode (step S176).

Accordingly, if the content providing server 5 transmits all pieces of content corresponding to the respective screen modes of the television 1, the television 1 displays, on the display 2, the content according to the current screen mode.

Note that the pieces of content corresponding to the respective screen modes of the television 1 may be stored in advance in the memory 4 of the television 1, instead of in the content providing server 5. In this case, when the screen mode is switched, the screen-mode acquiring section 13 acquires the current screen mode from the memory 4 in the television 1. Then, the content selecting section 14 acquires, from the memory 4, the content corresponding to the current screen mode, and supplies the content to the display section 11. Lastly, the display section 11 displays this supplied content on a split-screen corresponding to the content.

By the foregoing way, the television 1 displays a piece of content on each split-screen in a state suitable for the split-screen.

(Transmitting One Content Corresponding to all Screen Modes)

The content providing server 5 may transmit, to the television 1, a single piece of content that corresponds to all screen modes available in the television 1, instead of transmitting a single piece of content corresponding to the current screen mode of the television 1. In this case, the television 1 dynamically processes the single piece of content so that only a part of the content that corresponds to the current screen mode is displayed on the display 2.

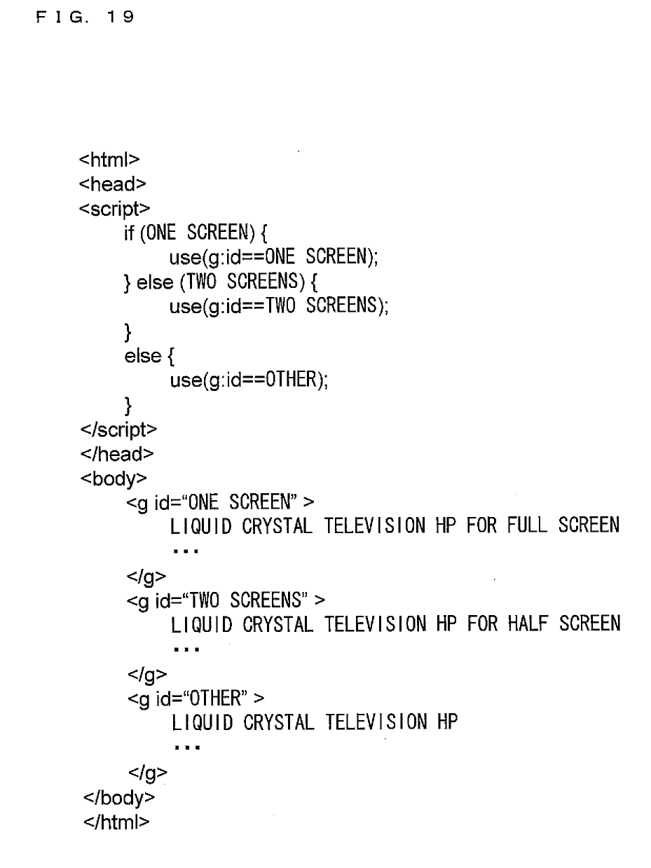

The following describes a flow in this process, with reference to FIG. 18. FIG. 18 is a flowchart showing another flow in the process of displaying the content in the content display system 30.

As shown in this figure, first there arises a content acquisition trigger (step S181). Then, the content-acquisition-request transmitting section 12 transmits the content acquisition request to the content providing server 5 (step S182). At this time, the content-acquisition-request transmitting section 12 transmits only an URI of the content that is desired to be acquired. In other words, the content-acquisition-request transmitting section 12 does not transmit information on the current screen mode.

In the content providing server 5, the content-acquisition-request receiving section 21 receives the content acquisition request (step S183). In the content providing server 5, information on all screen modes settable with the television 1 are stored in advance in the memory 6. Further, pieces of content corresponding to the respective screen modes are prepared in advance. An exemplary piece of the content is shown in FIG. 19. In the case shown in FIG. 19, the following tags are the scripts corresponding to the screen modes: <g id=“one screen”>; <g id=“two screens”>; and <g id=“other”>.

The content transmitting section 25 transmits, to the television 1, the content that correspond to all screen modes settable with the television 1 (step S184). For example if 16 screen modes are settable with the television 1, the content transmitting section 25 transmits, to the television 1, a single piece of content that contains all pieces of information corresponding to the respective 16 screen modes.

In the television 1, the content receiving section 16 receives the content transmitted from the content providing server 5 (step S185). The content receiving section 16 supplies the received content to the display section 11. At this time, the screen-mode acquiring section 13 acquires the current screen mode from the memory 4, and supplies the current screen mode to the display section 11. When displaying the content, the display section 11 processes a script that corresponds to the current screen mode, among scripts defined in the content supplied (step S186). Thus, the content is displayed on the display 2 in a state according to the current screen mode (step S187).

Accordingly, even if the content providing server 5 transmits the single piece of content corresponding to all screen modes of the television 1, the television 1 displays the content on the display 2 according to the current screen mode.

Note that the content corresponding to all screen modes of the television 1 may be prepared in the memory 4 of the television 1, instead of in the content providing server 5. In this case, when the screen mode is switched, the screen-mode acquiring section 13 acquires the current screen mode from the memory 4 and supplies the current screen mode to the display section 11 in the television 1. Then, the content selecting section 14 reads out, from the memory 4, the content corresponding to all split-screens, and supplies the content to the display section 11. Lastly, the display section 11 processes a script in the content thus supplied, thereby displaying the content on the display 2 in a state corresponding to the current screen mode.

By the foregoing way, the television 1 displays a piece of content on each split-screen in a state suitable for the split-screen.

(Process for Each Content Acquisition Trigger)

As the foregoing describes, the television 1 automatically switches the web page that is to be displayed, when triggered by a change in the position and shape of the web page displayed, details of the television program being displayed concurrently, or a state of the television (e.g. volume of sound).

For example if sound is muted, the television 1 does not show content that produces sound. If image quality is adjusted, the television 1 may set the background of the content to a chic tone in a cinema mode, and may set the background of the content to a bright color in a dynamic mode. If subtitles are displayed on the television, detailed descriptions in texts may be displayed on the web page that is concurrently displayed on the television 1. If the television program is displayed in bilingual broadcast, the television 1 switches the web page to English when sound is switched to English.

The television 1 may be arranged so as not to display information on functions available only in a one-screen mode, when the screen mode is a mode of two or more screens. This prevents the users from selecting by mistake a function that is not available.

(Displaying Content after a Split-Layout is Changed)

The users can provide an instruction to specify the layout of the split-screens by use of the input device 3. In this case, the operation accepting section 15 (layout specifying means) accepts the instruction to specify the layout of the split-screens. If the operation accepting section 15 accepts an instruction to change the current layout of the split-screens, it is preferable that the content selecting section 14 select content relevant to the content being displayed on one of the split-screens before the instruction is accepted, which content thus selected is to be displayed on another one of the split-screens after the instruction is accepted. Thus, when displaying the content of the same information, the content display device 1 displays other relevant content after the layout of the split-screens is changed. This allows the user to browse the content of the same information in a suitable state according to the layout of the split-screens.

(Acquiring Content to be Displayed from the Server)

When the operation accepting section 15 accepts an instruction to change the current layout of the split-screens, the content-acquisition-request transmitting section 12 may transmit, to the server device, a request for transmission of content that is to be displayed on the split-screens after the layout of the split-screens is changed. The content receiving section 16 acquires the content from the server. The display section 11 displays the content acquired by the content receiving section 14 on the split-screens after the layout of the split-screens is changed.

Specifically, after the layout of the split-screen is changed, the content display device 1 automatically accesses to the server to acquire display content, and causes the respective split-screens to display the content. This makes it unnecessary to store necessary content beforehand in the content display device 1, saving a storage space in the memory.

(Content Display Program and Recording Medium)

Lastly, the blocks included in the television 1 are configured with hardware logic. It is also possible to realize the blocks with software using a CPU (Central Processing Unit) as discussed below.

Specifically, the television 1 includes the CPU, which executes commands of a control program for realizing the functions, a ROM (Read Only Memory) storing the control program, a RAM (Random Access Memory) to store the control program in an executable format, and a storage unit (recording medium), such as a memory, storing the control program and various data.

With this configuration, the object of the present invention is also achievable by a predetermined recording medium. The recording medium records program codes (execute form program, intermediate code program, source program) of the control program of the television 1 that is software to realize the functions described above, which program codes are recorded so as to be readable by a computer. The recording medium is supplied to the television 1 so that the television 1 (or CPU or MPU), which is a computer, reads the program codes recorded in the recording medium to execute the program.

The recording medium to supply the program codes to the television 1 is not limited to a particular configuration or a particular type. The recording medium may be: a tape such as a magnetic tape and a cassette tape; a disk such as an magnetic disk (e.g., floppy (registered trademark) disk, hard disk) and an optical disk (e.g., CD-ROM, MO, MD, DVD, CD-R); a card such as an JC card (including memory card) and an optical card; and a semiconductor memory such as a mask ROM, an EPROM, an EEPROM, and a flash ROM.

The object of the present invention is also realizable by configuring the television 1 so as to be connectable to a communication network. In this case, the program codes are supplied to the television 1 via the communication network. The communication network is not limited to a particular type or a particular form, as long as the communication network allows the program codes to be supplied to the television 1. For example, the Internet, an intranet, an extranet, a LAN, an ISDN, a VAN, a CATV communication network, a virtual private network, a telephone line network, a mobile communication network, or a satellite communication network may be employed.

A transmission medium constituting the communication network is not limited to a particular configuration or a particular type, as long as the transmission medium allows the program codes to be transmitted. For example, a wire transmission medium, such as IEEE 1394, a USB, a power carrier line, a cable TV circuit, a telephone line, an ADSL circuit, and a wireless transmission medium, such as infrared rays (e.g., IrDA, remote-controller), Bluetooth (registered trademark), IEEE 802.11, an HDR, a mobile telephone network, a satellite circuit, or a terrestrial digital network may be employed. The present invention is also realizable in the form of a computer data signal that is concretized by electrical transmission of the program code and embedded in a carrier.

(Displaying Relevant Content)

It is preferable in the display device of the present invention that the content selecting means select, as second content to be displayed on a second split-screen, content that contains information on first content displayed on a first split-screen.

With this configuration, the content display device, for example, displays the television program on one split-screen, and displays, on another split-screen, content that contains sentences explaining the television program.

This allows a user to obtain supplementary information on one content from different content displayed simultaneously, when the user is browsing plural pieces of content displayed on plural split-screens. This is an advantageous effect.

(Displaying Television Programs and Web Pages)

It is preferable in the display device of the present invention that the content displaying means display, on a first split-screen, a television program as first content, and displays, on a second split-screen, a web page as second content containing information on the first content displayed on the first split-screen.

With this configuration, when watching the television program on one split-screen, the user can obtain supplementary information on the television program from the web page displayed on a different split-screen. This is an advantageous effect.

(Displaying Content after Split-Layout is Changed)

It is preferable in the display device of the present invention that the display device further include layout specifying means for accepting an instruction to specify a layout of the plurality of split-screens, the content selecting means selecting, when the layout specifying means accepts an instruction to change a current layout of the plurality of split-screens, second content relevant to first content displayed on a first split-screen before the instruction is accepted, which second content is to be displayed on a second split-screen after the instruction is accepted.

With this configuration, after the layout of the split-screens is changed, the content display device displays the same content in such a way that the same content and its relevant content are displayed. This allows the user to browse the content of the same information in a suitable state according to the layout of the split-screens. This is an advantageous effect.

(Obtaining Content to be Displayed from Server)

It is preferable in the display device of the present invention that the display device further include: content acquiring means for acquiring, when the layout specifying means accepts an instruction to change a current layout of the plurality of split-screens, content from a server, which content is to be displayed on the plurality of split-screens after the layout of the plurality of split-screens is changed, the content displaying means displaying, on the plurality of split-screens after the layout of the plurality of split-screens is changed, the content acquired by the content acquiring means.

With this configuration, after the layout of the split-screens is changed, the content display device automatically accesses the server to acquire the content that is to be displayed, and causes the respective split-screens to display the content. Thus, there is no need to store in advance necessary content in the display device, so that the space in the memory is saved. This is an advantageous effect.

(Generating Content to be Displayed)

It is preferable that the content providing server further include: content generating means for generating, on a basis of the information thus received and predetermined template data prepared in advance for each of the plurality of split-screens, the corresponding content for each of the plurality of split-screens; and the content selecting means selects the content thus generated.

With this configuration, an advantageous effect is produced that the content display system efficiently generates pieces of content corresponding to the respective split-screens.

(Template Date in which a Process is Defined)

It is preferable that the content generating means generate the content by executing a predetermined process defined in the template data.

With this arrangement, an advantage is produced that the content display system dynamically generates suitable content for each template data.

(Obtaining Supplementary Information from External Device)

It is preferable that the content generating means acquire information from an external device, which information is to be included in the content, by executing a predetermined process defined in the template data.

With this arrangement, content with different information is generated dynamically according to the situation. Thus, for example information on a television program that is currently on air is obtained from a server device of a broadcast station providing the television program, and a web page containing this supplementary information is generated.

As the foregoing discusses, the content display device of the present invention includes the content displaying means for displaying, on a split-screen, content assigned in advance with the split-screens. Thus, an advantage is produced that the content is displayed in a state suitable for each split-screen.

The present invention is widely applicable to content display devices (television) in which a single screen is split into a plurality of split-screens each displaying different content.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A content display device wherein a single screen is split into a plurality of split-screens each displaying different content,
the content display device comprising:
content selecting means for selecting, for each of the plurality of split-screens, content assigned in advance to each of the plurality of split-screens; and
content displaying means for displaying the content selected, on a corresponding one of the plurality of split-screens.

2. The content display device of claim 1, wherein the content selecting means selects, as second content to be displayed on a second split-screen, content that contains information on first content displayed on a first split-screen.

3. The content display device of claim 1, wherein the content displaying means displays, on a first split-screen, a television program as first content, and displays, on a second split-screen, a web page as second content containing information on the first content displayed on the first split-screen.

4. The content display device of claim 3, wherein when the screen is split into two split-screens, the content displaying means causes one of the split-screens to display the television program, and causes the other one of the split-screens to display content that is relevant to, but contains a smaller amount of information than, the content that is displayed when the screen is not split.

5. The content display device of claim 1, further comprising:
layout specifying means for accepting an instruction to specify a layout of the plurality of split-screens,
the content selecting means selecting, when the layout specifying means accepts an instruction to change a current layout of the plurality of split-screens, second content relevant to first content displayed on a first split-screen before the instruction is accepted, which second content is to be displayed on a second split-screen after the instruction is accepted.

6. The content display device of claim 4, further comprising:
content acquiring means for acquiring, when the layout specifying means accepts an instruction to change a current layout of the plurality of split-screens, content from a server, which content is to be displayed on the plurality of split-screens after the layout of the plurality of split-screens is changed,
the content displaying means displaying, on the plurality of split-screens after the layout of the plurality of split-screens is changed, the content acquired by the content acquiring means.

7. A content display method wherein a single screen is split into a plurality of split-screens each displaying different content,
the method comprising the steps of:
selecting, for each of the plurality of split-screens, content assigned in advance to each of the plurality of split-screens; and
displaying the content selected, on a corresponding one of the plurality of split-screens.

8. A content display system, comprising:
a content display device wherein a single screen is split into a plurality of split-screens each displaying different content; and
a server device that provides the content to the content display device,
the content display device comprising:
transmitting means for transmitting, to the server device, information on the plurality of split-screens; and
content displaying means for displaying the content transmitted from the server device, on a corresponding one of the plurality of split-screens, the server device comprising:
receiving means for receiving the information on the plurality of split-screens, which information is transmitted from the display device;
content selecting means for selecting, on a basis of the information thus received, corresponding content for each of the plurality of split-screens; and
content transmitting means for transmitting, to the content display device, the content thus selected.

9. The content display system of claim 7, wherein:
the content providing server further comprises content generating means for generating, on a basis of the information thus received and predetermined template data prepared in advance for each of the plurality of split-screens, the corresponding content for each of the plurality of split-screens; and
the content selecting means selects the content thus generated.

10. The content display system of claim 8, wherein the content generating means generates the content by executing a predetermined process defined in the template data.

11. The content display system of claim 10, wherein the predetermined process is execution of a replacement script defined in a tag contained in the template data.

12. The content display system of claim 8, wherein the content generating means acquires information from an external device, which information is to be included in the content, by executing a predetermined process defined in the template data.

13. The content display system of claim 8, wherein the template data is HTML data describing a web page.

14. A content display program for causing a content display device defined in claim 1 to operate, the program causing a computer to function as each one of the means.

15. A computer-readable recording medium, storing the content display program defined in claim 11.
